(19) United States
(12) Patent Application Publication
(10) Pub. No.: US 2020/0130133 A1
(43) Pub. Date: Apr. 30, 2020

(54) ABRASIVE ARTICLES INCLUDING CONFORMABLE COATINGS AND POLISHING SYSTEM THEREFROM

(71) Applicant: 3M INNOVATIVE PROPERTIES COMPANY, St. Paul, MN (US)

(72) Inventors: Chi-Fan Chen, Taichung City (TW); Justin A. Riddle, St. Paul, MN (US); Vincent J. Laraia, Houlton, WI (US); Caleb T. Nelson, Woodbury, MN (US); Wen-Hsiang Hsieh, Taipei City (TW); Moses M. David, Wells, TX (US); Naiyong Jing, St. Paul, MN (US); Jun MA, Woodbury, MN (US)

(21) Appl. No.: 16/629,987

(22) PCT Filed: Jul. 5, 2018
(86) PCT No.: PCT/IB2018/054980

§ 371 Date: Jan. 10, 2020

Related U.S. Application Data
(60) Provisional application No. 62/530,989, filed on Jul. 11, 2017.

(51) Int. Cl. B24B 37/24; B24B 53/017; B24D 3/34; C09K 3/14; B24D 3/28

(52) U.S. Cl. CPC B24B 37/24; B24B 53/017; B24D 3/28; C09K 3/1409; B24D 3/346

(57) ABSTRACT

The present disclosure relates to abrasive articles including conformable coatings, e.g. a hydrophilic coating, and polishing systems therefrom. The present disclosure provides an abrasive article including a body having an abrading surface and an opposed second surface, wherein the abrading surface of the body includes a plurality of inorganic abrasive particles; a conformable metal oxide coating adjacent to and conforming to the plurality of engineered features, wherein the conformable metal oxide coating includes a first surface; and a conformable polar organic-metallic coating in contact with the first surface of the conformable metal oxide coating, wherein the conformable polar organic-metallic coating includes a chemical compound having at least one metal and an organic moiety having at least one polar functional group.

### TECHNICAL FIELD

The present disclosure relates to abrasive articles having conformable coatings, for example pad conditioners having conformable coatings, and polishing systems therefrom.

### BACKGROUND

Abrasive articles having a coating have been described in, for example, U.S. Pat. Nos. 5,921,856; 6,368,198 and 8,905,823 and U.S. Pat. Publ. Nos. 2011/0053479 and 2017/0008143.

### SUMMARY

Abrasive articles are typically used to abrade various substrates, in order to remove a portion of the abraded substrate surface from the substrate itself. The material removed from the substrate surface is typically called swarf. One problem with abrasive articles is that swarf can build up on the abrading surface of the abrasive article, reducing the abrasive article's ability to abrade. Removing the swarf from the abrasive article is often difficult, as it can readily adhere to the abrading surface of the abrasive article.

In chemical mechanical planarization (CMP) applications, a polishing system may include a polishing pad, often a polymeric based material, e.g. polyurethane; an abrasive article designed to abrade the pad, e.g. a pad conditioner; a substrate being polished, e.g. a semiconductor wafer; and a working liquid, e.g. a polishing slurry containing abrasive particles, designed to polish/abrade the substrate being polished. During polishing of the wafer with the polishing slurry and the polishing pad, the polishing pad can become glazed over with abrasive particles from the slurry, which reduces the polishing pads ability to polish the wafer in a consistent manner. Pad conditioners, which may contain a diamond particle abrading layer, a ceramic abrading layer or a diamond coated ceramic abrading layer, are often used to abrade the polishing pad in order to remove the glaze and/or expose new polishing pad surface, thereby maintaining consistent polishing performance of the pad over long periods of polishing time. However, during use, the pad conditioner is prone to swarf build-up, e.g. polishing pad material abraded from the polishing pad and/or abrasive particles from the slurry may adhere to the abrading surface of the pad conditioner. This phenomenon reduces the pad conditioner's ability to remove the glaze from the polishing pad and/or expose new polishing pad surface and ultimately leads to reduced polishing performance of the polishing pad itself. To improve this situation, a pad conditioner is needed that has an abrading surface that reduces swarf build-up and/or can be easily cleaned of swarf.

The present disclosure relates to abrasive articles having a unique hydrophilic surface. The hydrophilic surface improves wettability of the abrasive article's surface and may lead to enhanced anti-fouling capabilities and/or enhanced cleaning capabilities due to the hydrophilic surface of the abrasive article. This contrasts with prior art, e.g. U.S. Pat. Appl. Publ. 2011/0053479 (Kim et al.), which suggests that hydrophobic cutting surfaces are required to prevent contamination of a cutting tool surface, e.g. a pad conditioner surface. The present disclosure also provides polishing systems that incorporate the abrasive articles of the present disclosure.

In one embodiment, the present disclosure provides and abrasive article comprising:

a body having an abrading surface and an opposed second surface, wherein the abrading surface of the body includes a plurality of inorganic abrasive particles;

a conformable metal oxide coating adjacent to and conforming to the plurality of abrasive particles, wherein the conformable metal oxide coating includes a first surface; and

a conformable polar organic-metallic coating in contact with the first surface of the conformable metal oxide coating. In some embodiments, the conformable polar organic-metallic coating includes a chemical compound having at least one metal and an organic moiety having at least one polar functional group. Optionally, the at least one metal of the conformable polar organic-metallic coating may be at least one of Si, Ti, Zr and Al. The body may have a thickness between from 4 mm to 25 mm. In some embodiments, the projected surface area of the abrading surface is between from 500 mm² to 500000 mm². In some embodiments, the inorganic abrasive particles have a Mohs hardness of at least 7.5 and/or a Vickers hardness of at least 1300 kg/mm²

In yet another embodiment the present disclosure provides a polishing system comprising:

a polishing pad including a material;

a pad conditioner having an abrading surface, wherein the pad conditioner includes at least one abrasive article according to any one of the abrasive articles of the present disclosure, wherein the abrading surface of the pad conditioner includes the conformable polar organic-metallic coating of the at least one abrasive article.

### BRIEF DESCRIPTION OF THE DRAWINGS

FIG. 1A is a schematic top view of at least a portion of an exemplary abrasive article according to one exemplary embodiment of the present disclosure.

FIG. 1B is a schematic cross-sectional view of the exemplary abrasive article of FIG. 1A, through line 1B, according to one exemplary embodiment of the present disclosure.

FIG. 2 is a schematic top view of a segmented pad conditioner according to one exemplary embodiment of the present disclosure.

FIG. 3 is a schematic diagram of an exemplary polishing system for utilizing an abrasive article in accordance with some embodiments of the present disclosure.

Repeated use of reference characters in the specification and drawings is intended to represent the same or analogous features or elements of the disclosure. The drawings may not be drawn to scale. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

Throughout this disclosure the phrase “conformable coating” refers to a coating that coats and conforms to the abrading surface that includes the plurality of inorganic abrasive particles or to a surface with topography. The coating conforms to the abrasive particles surface topography or a surface's topography, in general, and does not completely fill in the surface topography to produce a planar surface, e.g. the coating does not planarize the plurality of inorganic abrasive particles or the surface with topography.

Throughout this disclosure the term “polar organic-metallic” means a chemical compound having at least one metal (e.g. alkali, alkaline earth, transition and semiconductor metal) and an organic moiety having at least one polar functional group.

Throughout this disclosure the term “organometallic” means a chemical compound containing at least one bond between a carbon atom of an organic compound and a metal, including transition metal and semiconductor metals.

### DETAILED DESCRIPTION

The present disclosure relates to abrasive articles useful in a variety of abrading applications. The abrasive articles of the present disclosure show particular utility as pad conditioners or elements of segmented pad conditioners and may be used in a variety of CMP applications. The abrasive articles of the present disclosure show unique anti-fouling and/or cleaning characteristics associated with a hydrophilic surface located adjacent an abrading surface of the abrasive article's body. The hydrophilic surface is the result of one or more conformable coatings applied to the abrading surface of the abrasive article's body. The hydrophilic surface may be associated with a polar organic-metallic coating applied adjacent to the abrading surface of the abrasive article. The abrasive articles of the present disclosure include a body having an abrading surface, i.e. a surface designed for abrading a substrate, and a polar organic-metallic coating adjacent to the abrading surface. The abrading surface may include a plurality of inorganic abrasive particles. The inorganic abrasive particles may have a Mohs hardness of at least 7.5 and/or a Vickers hardness of at least 1300 kg/mm². The polar organic-metallic coating may be a conformable coating, conforming to any topography on the abrading surface, including the inorganic abrasive particles. The polar organic-metallic coating may include a chemical compound having at least one metal and an organic moiety having at least one polar functional group. The at least one metal may be at least one of Si, Ti, Zr and Al. The polar organic-metallic coating may include an organometallic compound. The abrasive article may further include a metal oxide coating disposed between the abrading surface of the body and the polar organic-metallic coating. The metal oxide coating may facilitate bonding of the polar organic-metallic coating to the abrasive article's body. The metal oxide coating may also be hydrophilic and contribute to the hydrophilic nature of the final abrading surface (the abrading surface after coating) of the abrasive article. The metal oxide coating may also increase the durability and shelf life of the hydrophilic coating, as compared to a plasma coating for example, enabling the abrasive article to maintain its anti-fouling characteristics over longer periods of time. The metal oxide may be a conformable coating, conforming to any topography on the abrading surface, including the inorganic abrasive particles. The abrasive article may include an optional diamond coating disposed between the abrading surface of the body and the polar organic-metallic coating. The abrasive article may include an optional diamond coating disposed between the abrading surface of the abrasive article's body and the metal oxide coating. The diamond coating may improve the chemical resistance, wear resistance and/or strength of the abrading surface of the abrasive article's body, facilitating longer abrading life of the abrasive article. The diamond coating may be a conformable coating, conforming to any topography on the abrading surface, including the inorganic abrasive particles. The surface of the diamond coating may be oxidized to facilitate bonding to the polar organic-metallic coating or the metal oxide coating. If the surface of the diamond coating is oxidize, the oxidized surface may be considered a metal oxide coating, herein, even though, conventionally, an oxidized carbon would not be considered a metal oxide coating. With the exception of the inclusion of an oxidized diamond surface, the term “metal oxide” has its conventional meaning in the art, herein.

The abrasive articles of the present disclosure include a body having an abrading surface and an opposed second surface; the abrading surface includes a plurality of inorganic abrasive particles. The abrasive articles include at least one conformable polar organic-metallic coating and the polar organic-metallic coating may include a chemical compound having at least one metal and an organic moiety having at least one polar functional group. The at least one metal may be at least one of Si, Ti, Zr and Al. The polar organic-metallic coating is adjacent to the abrading surface of the body. The abrasive articles may further include a metal oxide coating, e.g. a conformable metal oxide coating, disposed between the abrading surface of the body and the at least one conformable polar organic-metallic coating. The abrasive articles may further include an optional diamond coating, e.g. a conformable diamond coating. In some embodiments, the diamond coating may be disposed between the abrading surface of the body and the at least one conformable polar organic-metallic coating. In some embodiments, the diamond coating may be disposed between the abrading surface of the body and the metal oxide coating. A combination including all three coatings may also be used. In some embodiments, the surface of the diamond coating may be oxidized and may include oxygen.

The conformable polar organic-metallic coating may include a chemical compound having at least one metal and an organic moiety having at least one polar functional group. The at least one polar functional group of the organic moiety includes, but is not limited to, at least one of a hydroxyl, an acid (e.g. carboxylic acid), a primary amine, a secondary amine, a tertiary amine, a methoxy, an ethoxy, a propoxy, a ketone, a cationic and an anionic functional group. In some embodiments, the at least one polar functional group includes at least one of a cationic functional group and an anionic functional group. In some embodiments, the at least one polar functional group includes at least one cationic functional group and one anionic functional group, e.g. a zwitterion. In some embodiments, the conformable polar organic-metallic coating may include a chemical compound having at least one metal and an organic moiety having at least two polar functional groups. In some embodiments, the at least two polar functional groups may be the same functional groups. In some embodiments, the at least two polar functional groups may be different functional groups. In some embodiments, the conformable polar organic-metallic coating may be an organosilane including, but not limited to, at least one of an organochlorosilane, an organosilanol and an alkoxysilane, i.e. the chemical compound having at least one metal and an organic moiety having at least one polar functional group may be an organosilane, including, but not limited to, at least one of an organochlorosilane, an organosilanol and an alkoxysilane. Useful organosilanes include, but are not limited to, at least one of n-trimethoxysilylpropyl-n,n,n-trimethylammonium chloride, n-(trimethoxysilylpropyl)ethylenediaminetriacetate trisodium salt, carboxyethylsilanetriol disodium salt, 3-(trihydroxysilyl)-1-propanesulfonic acid and n-(3-triethoxysilylpropyl)gluconamide The conformable polar organic-metallic coating may further include at least one of lithium silicate, sodium silicate and potassium silicate.

Particularly useful conformable polar organic-metallic coatings may include zwitterionic silanes. Zwitterionic silanes are neutral compounds that have electrical charges of opposite sign within a molecule, as described in http://goldbook.iupac.org/Z06752.html. Such compounds provide easy-to-clean performance to the coatings.

Suitable zwitterionic silanes include a zwitterionic sulfonate-functional silane, a zwitterionic carboxylate-functional silane, a zwitterionic phosphate-functional silane, a zwitterionic phosphonic acid-functional silane, a zwitterionic phosphonate-functional silane, or a combination thereof. In certain embodiments, the zwitterionic silane is a zwitterionic sulfonate-functional silane.

In certain embodiments, the zwitterionic silane compounds used in the present disclosure have the following Formula (I) wherein:

(R¹O)ₚ—Si(Q¹)_{q}-W—N⁺(R²)(R³)—(CH₂)ₘ—Z^{t-} (I)

wherein:

each R¹ is independently a hydrogen, methyl group, or ethyl group;

each Q¹ is independently selected from hydroxyl, alkyl groups containing from 1 to 4 carbon atoms, and alkoxy groups containing from 1 to 4 carbon atoms;

each R² and R³ is independently a saturated or unsaturated, straight chain, branched, or cyclic organic group (preferably having 20 carbons or less), which may be joined together, optionally with atoms of the group W, to form a ring;

W is an organic linking group;

Z^{t-} is −SO₃⁻, —CO₂⁻, —OPO₃²⁻, —PO₃²⁻, —OP(═O)(R)O⁻, or a combination thereof, wherein t is 1 or 2, and R is an aliphatic, aromatic, branched, linear, cyclic, or heterocyclic group (preferably having 20 carbons or less, more preferably R is aliphatic having 20 carbons or less, and even more preferably R is methyl, ethyl, propyl, or butyl);

p and m are integers of 1 to 10 (or 1 to 4, or 1 to 3);

q is 0 or 1; and

p+q=3.

In certain embodiments, the organic linking group W of Formula (I) may be selected from saturated or unsaturated, straight chain, branched, or cyclic organic groups. The linking group W is preferably an alkylene group, which may include carbonyl groups, urethane groups, urea groups, heteroatoms such as oxygen, nitrogen, and sulfur, and combinations thereof. Examples of suitable linking groups W include alkylene groups, cycloalkylene groups, alkyl-substituted cycloalkylene groups, hydroxy-substituted alkylene groups, hydroxy-substituted mono-oxa alkylene groups, divalent hydrocarbon groups having mono-oxa backbone substitution, divalent hydrocarbon groups having mono-thia backbone substitution, divalent hydrocarbon groups having monooxo-thia backbone substitution, divalent hydrocarbon groups having dioxo-thia backbone substitution, arylene groups, arylalkylene groups, alkylarylene groups and substituted alkylarylene groups.

Suitable examples of zwitterionic compounds of Formula (I) are described in U.S. Pat. No. 5,936,703 (Miyazaki et al.) and International Publication Nos. WO 2007/146680 and WO 2009/119690, and include the following zwitterionic functional groups (—W—N₊(R³)(R⁴)—(CH₂)ₘ—SO₃⁻):

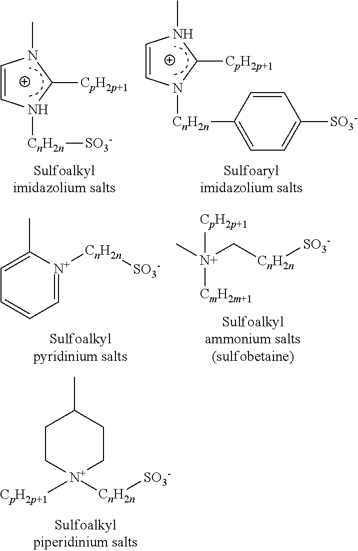

In certain embodiments, the zwitterionic sulfonate-functional silane compounds used in the present disclosure have the following Formula (II) wherein:

(R¹O)ₚ—Si(Q¹)_{q}-CH₂CH₂CH₂—N⁺(CH₃)₂—(CH₂)ₘ—SO₃⁻ (II)

wherein:

each R¹ is independently a hydrogen, methyl group, or ethyl group;

each Q¹ is independently selected from hydroxyl, alkyl groups containing from 1 to 4 carbon atoms and alkoxy groups containing from 1 to 4 carbon atoms;

p and m are integers of 1 to 4;

q is 0 or 1; and

p+q=3.

Suitable examples of zwitterionic sulfonate-functional compounds of Formula (II) are described in U.S. Pat. No. 5,936,703 (Miyazaki et al.), including, for example:

(CH₃O)₃Si—CH₂CH₂CH₂—N⁺(CH₃)₂—CH₂CH₂CH₂—SO₃⁻; and

(CH₃CH₂O)₂Si(CH₃)—CH₂CH₂CH₂—N⁺(CH₃)₂—CH₂CH₂CH₂—SO₃⁻.

Other examples of suitable zwitterionic sulfonate-functional compounds, which may be made using standard techniques include the following:

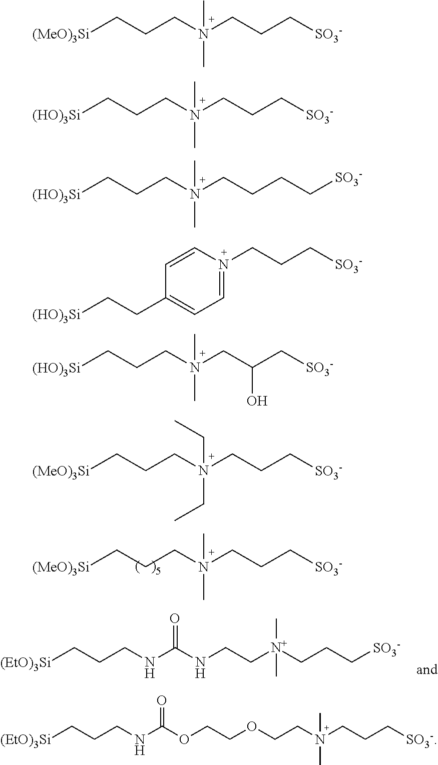

Preferred examples of suitable zwitterionic sulfonate-functional silane compounds for use in the present disclosure are described in the Experimental Section. A particularly preferred zwitterionic sulfonate-functional silane is:

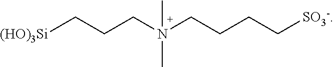

Examples of zwitterionic carboxylate-functional silane compounds include

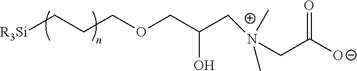

wherein each R is independently OH or alkoxy, and n is 1-10.

Examples of zwitterionic phosphate-functional silane compounds include:

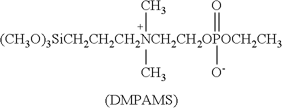

(N,N-dimethyl,N-(2-ethyl phosphate ethyl)-aminopropyl-trimethyoxysilane (DMPAMS)).

Examples of zwitterionic phosphonate-functional silane compounds include:

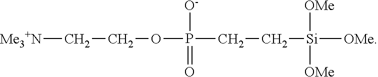

In some embodiments, the conformable polar organic-metallic coatings of the present disclosure include a zwitterionic silane compound in an amount of at least 0.0001 weight percent (wt-%), or at least 0.001 wt-%, or at least 0.01 wt-%, or at least 0.05 wt-%, based on the total weight of a ready-to-use composition. In some embodiments, compositions of the present disclosure include a zwitterionic silane compound in an amount of up to 10 wt-%, or up to 5 wt-%, or up to 2 wt-%, based on the total weight of a ready-to-use composition.

In some embodiments, the conformable polar organic-metallic coatings of the present disclosure include a zwitterionic silane compound in an amount of at least 0.0001 weight percent (wt-%), or at least 0.001 wt-%, or at least 0.01 wt-%, or at least 0.1 wt-%, or at least 0.5 wt-%, based on the total weight of a concentrated composition. In some embodiments, compositions of the present disclosure include a zwitterionic silane compound in an amount of up to 20 wt-%, or up to 15 wt-%, or up to 10 wt-%, based on the total weight of a concentrated composition.

The metal of the conformable metal oxide coating may include at least one of an alkali metal, alkaline earth metal, a transition metal and a semiconductor metal. Semiconductor metal include Si, Ga and the like. In some embodiments, the metal of the metal oxide includes at least one of Al, Ti, Cr, Mg, Mn, Fe, Co, Ni, Cu, W, Zn, Zr, Ga and Si. Combinations may be used.

In some embodiments, the abrasive article includes a conformable metal oxide coating adjacent to and conforming to the abrading surface, e.g. the abrading surface including a plurality of inorganic abrasive particles, wherein the conformable metal oxide coating includes a first surface; and a conformable polar organic-metallic coating in contact with the first surface of the conformable metal oxide coating. The conformable polar organic-metallic coating includes a chemical compound having at least one metal and an organic moiety having at least one polar functional group. The conformable metal oxide coating may be in contact with the plurality of inorganic abrasive particles of the abrading surface of the body. In some embodiments, the contact angle of water on the conformable polar organic-metallic coating of the abrasive article is less than 30 degrees, less than 20 degrees, less than 10 degrees, less than 5 degrees or even less than 2 degrees. In some embodiments, the contact angle of water on the conformable polar organic-metallic coating of the abrasive article is between from 0 to 30 degrees, between from 0 to 20 degrees, between from 0 to 10 degrees, between from 0 to 5 degrees or even between from 0 to 1.5 degrees. The chemical compound having at least one metal and an organic moiety having at least one polar functional group may be an organosilane and the conformable polar organic-metallic coating may include the reaction product of the organosilane and the metal oxide of the conformable metal oxide coating. In some embodiments, the metal of the metal oxide may include Si, the organosilane of the conformable polar organic-metallic coating may include an alkoxysilane, and the at least one polar functional group of the conformable polar organic-metallic coating may include at least one of a cationic functional group and an anionic functional group. The abrasive article may include an, optional, conformable, diamond coating disposed between the abrading surface of the body of the abrasive article and the conformable metal oxide coating.

The size and type of inorganic abrasive particles are selected to achieve the desired characteristics of the abrasive article depending on its intended application. The term “abrasive particles” includes single inorganic abrasive particles bonded together by a binder to form an abrasive agglomerate or composite. Abrasive agglomerates are further described in U.S. Pat. No. 4,311,489 (Kressner), U.S. Pat. No. 4,652,275 (Bloecher et al.), and U.S. Pat. No. 4,799,939 (Bloecher et al). The abrasive particles may further include a surface treatment or coating, such as a coupling agent or a metal or ceramic coating. In some embodiments, the inorganic abrasive particles have an average size of from 10 to 1000 micrometers, from 20 to 1000 micrometers, from 45 to 625 micrometers, or even from 75 to 300 micrometers. Occasionally, abrasive particle sizes are reported in terms of “mesh” or “grade,” both of which are commonly known abrasive particle sizing methods. It is preferred that the inorganic abrasive particles have a Mohs hardness of at least 7.5 and, more preferably, at least 8 or even at least 9. Suitable inorganic abrasive particles include, for example, fused aluminum oxide, ceramic aluminum oxide, heat treated aluminum oxide, silicon carbide, boron carbide, tungsten carbide, alumina zirconia, iron oxide, diamond (natural and synthetic), cerin, cubic boron nitride, garnet, carborundum, boron suboxide, and combinations thereof. The inorganic abrasive particles may have a narrow size distribution, with the percent non-uniformity of a distribution of particles being from 0 to 10 percent, 0 to 5 percent or even from 0 to 3 percent. The percent non-uniformity is the standard deviation of a size distribution of particles divided by the average size of the particle in the distribution multiplied by 100.

The inorganic abrasive particles of the abrasive article may have a Mohs hardness of at least 7.5, at least 8, at least 8.5 or even at least 9 and/or a Vickers hardness of at least 1300 kg/mm², at least 1500 kg/mm², at least 2000 kg/mm² or even at least 3000 kg/mm². In some embodiments, the inorganic abrasive particles have a Mohs hardness between from 7.5 to 10, between from 8 to 10, between from 8.5 to 10, or even between from 9 and 10 and/or a Vickers hardness between from 1300 kg/mm² and 10000 kg/mm², between from 1300 kg/mm² and 4000 kg/mm², between from 1300 kg/mm² and 3000 kg/mm², between from 1500 kg/mm² and 10000 kg/mm², between from 1500 kg/mm² and 4000 kg/mm² or even between from 1300 kg/mm² and 3000 kg/mm². Generally, abrasive particles having a high Mohs (at least about 7.5) and/or Vickers hardness (at least about 1300 kg/mm²) have particular utility, as they are capable of withstanding the abrading action that occurs during an abrading process and/or the often harsh chemical environment found in, for example, CMP applications.

The body may include a first substrate, e.g. a ceramic substrate, a metal substrate, e.g. a stainless steel substrate, or a polymeric substrate, e.g. a thermoset or thermoplastic. Various metal, ceramic and polymeric materials known in the art may be used for the first substrate, corrosion resistant metal, ceramic and polymeric substrates having particular utility. The body may include a bonding material useful for affixing the inorganic abrasive particles to the first substrate. The inorganic abrasive particles may be affixed to the first substrate of the body by materials known in the art including, but not limited to, at least one of a metal, a metal alloy and a thermoset adhesive. Known techniques in the art may be used to affix the inorganic abrasive particles to the first substrate. Examples of useful first substrates, bonding material for affixing the abrasive particles to the first substrate of the body and bonding techniques are disclosed in, for example, U.S. Pat. No. 6,123,612 (Gores), which is incorporated herein by reference in its entirety. The ceramic substrate may be a monolithic ceramic substrate. A monolithic ceramic substrate is a substrate that consists essentially of the ceramic it is composed of and has a continuous, ceramic structure throughout, e.g. a continuous, ceramic morphology throughout. The ceramic morphology may be a single phase. A monolithic ceramic is generally designed to erode very slowly, preferably not at all, and contains no abrasive particles that may be release from the monolithic ceramic. The polymeric substrate may be a thermoset, e.g. phenolic resin, or a thermoplastic, e.g. polycarbonate, polyester, polysulphone.

In one embodiment, the present disclosure provides an abrasive article comprising:

a body having an abrading surface and an opposed second surface, wherein the abrading surface of the body includes a plurality of inorganic abrasive particles;

a conformable metal oxide coating adjacent to and conforming to the plurality of inorganic abrasive particles, wherein the conformable metal oxide coating includes a first surface; and

a conformable polar organic-metallic coating in contact with the first surface of the conformable metal oxide coating, wherein the conformable polar organic-metallic coating includes a chemical compound having at least one metal and an organic moiety having at least one polar functional group. In some embodiments, the at least one metal is at least one of Si, Ti, Zr and Al.

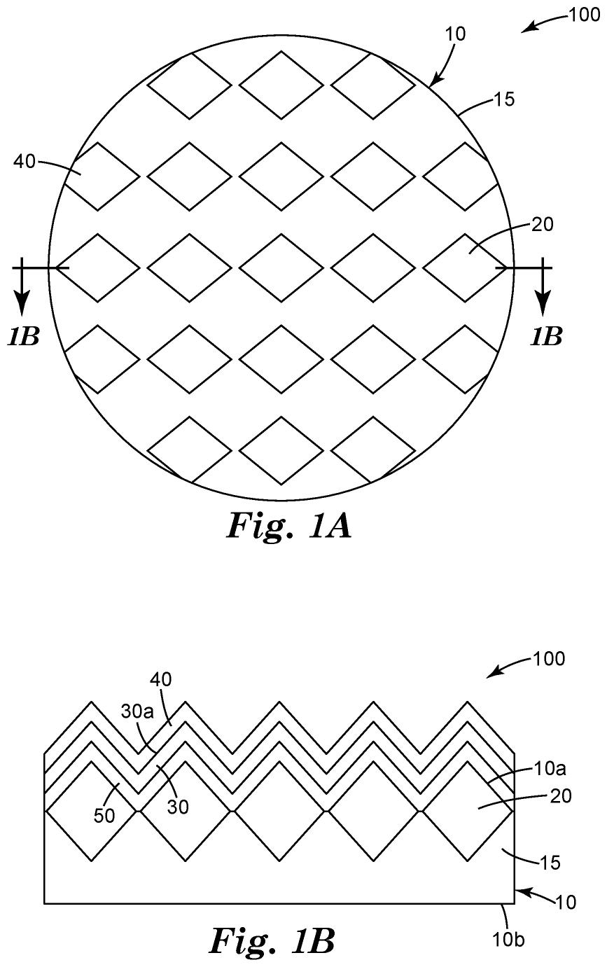

FIG. 1A is a schematic top view of at least a portion of an exemplary abrasive article according to one exemplary embodiment of the present disclosure and FIG. 1B is a schematic cross-sectional view of the exemplary abrasive article of FIG. 1A, through line 1B, according to one exemplary embodiment of the present disclosure. FIGS. 1A and 1B show at least a portion of an abrasive article 100 including a body 10 having an abrading surface 10a and an opposed second surface 10b, wherein the abrading surface 10a of the body includes a plurality of inorganic abrasive particles 20 and body 10 may also include first substrate 15. The inorganic abrasive particles 20 may be affixed to first substrate 15. As shown in FIG. 1A, the at least a portion of an abrasive article 100 has a projected surface area equal to the area of the large circle which defines the perimeter of abrasive article 100. Abrasive article 100 further includes a conformable metal oxide coating 30 adjacent to and conforming to the plurality of inorganic abrasive particles 20, wherein the conformable metal oxide coating 30 includes a first surface 30a, and a conformable polar organic-metallic coating 40 in contact with the first surface 30a of the conformable metal oxide coating 30. The conformable polar organic-metallic coating 40 may include a chemical compound having at least one metal, e.g. at least one of Si, Ti, Zr and Al, and an organic moiety having at least one polar functional group. Abrasive article 100 may, optionally, include a conformable, diamond coating 50 disposed between the abrading surface 10a of body 10 and the conformable metal oxide coating 40. The diamond coating, if used, may be in contact with abrading surface 10a of body 10. In some embodiments, metal oxide coating 30 is adjacent to and in contact with the abrading surface 10a of body 10. In some embodiments, metal oxide coating 30 is adjacent to and in contact with conformable, diamond coating 50.

The areal density of the plurality of inorganic abrasive particles is not particularly limited. In some embodiments, the areal density of the plurality of inorganic abrasive particles may be from 0.5/cm² to 1×10⁴/cm², from 0.5/cm² to 1×10³/cm², from 0.5/cm² to 1×10²/cm², from 0.5/cm² to 1×10¹/cm², from 1/cm² to 1×10⁴/cm², from 1/cm² to 1×10³/cm², from 1/cm² to 1×10²/cm², from 1/cm² to 1×10¹/cm², from 10/cm² to 1×10⁴/cm², from 10/cm² to 1×10³/cm², from 10/cm² to 1×10²/cm², or even from 10/cm² to 1×10¹/cm². The areal density of the inorganic abrasive particles may vary across the abrading surface of the abrasive article. The inorganic abrasive particles may be arranged randomly or may be arranged in a pattern, e.g. square grid array or hexagonal array, on the abrading surface.

Exemplary bodies, having an abrading surface and an opposed second surface, wherein the abrading surface of the body includes a plurality of inorganic abrasive particles, useful in the abrasive articles of the present disclosure, include diamond pad conditioners known in the art, including, but not limited to, diamond pad conditioners available under the trade designations 3M DIAMOND PAD CONDITONER and 3M DIAMOND PAD CONDITONER RING available from the 3M Company, St. Paul, Minn. For example, 3M DIAMOND PAD CONDITONER A153L, 3M DIAMOND PAD CONDITONER A160 series (includes A160, A165, A165P, A166 and A168, for example), 3M DIAMOND PAD CONDITONER A180 series (includes A181, A188F, A188H, A188J, A188JH, A188K and A188L, for example), 3M DIAMOND PAD CONDITONER A270, 3M DIAMOND PAD CONDITONER A272, 3M DIAMOND PAD CONDITONER A2800 series (includes A2810, A2812, A2813 and A2850, for example), 3M DIAMOND PAD CONDITONER A3700, 3M DIAMOND PAD CONDITONER A3799, 3M DIAMOND PAD CONDITONER A4-55, 3M DIAMOND PAD CONDITONER A63, 3M DIAMOND PAD CONDITONER A82, 3M DIAMOND PAD CONDITONER A92, 3M DIAMOND PAD CONDITONER C123, 3M DIAMOND PAD CONDITONER H80-AL, 3M DIAMOND PAD CONDITONER H91, 3M DIAMOND PAD CONDITONER S122, 3M DIAMOND PAD CONDITONER S60, 3M DIAMOND PAD CONDITONER S82, 3M DIAMOND PAD CONDITONER S98, 3M DIAMOND PAD CONDITONER RING E187, 3M DIAMOND PAD CONDITONER RING E221, 3M DIAMOND PAD CONDITONER RING E3910, 3M DIAMOND PAD CONDITONER RING E3920 and 3M DIAMOND PAD CONDITONER RING E3921 may be used.

The abrasive articles include at least one conformable coating. The at least one conformable coating includes a conformable polar organic-metallic coating, which includes a chemical compound having at least one metal, e.g. at least one of Si, Ti, Zr and Al, and an organic moiety having at least one polar functional group. The abrasive article may further include a conformable metal oxide coating disposed between the abrading surface of the body of the abrasive article and the at least one conformable polar organic-metallic coating. The metal oxide coating may be in contact with the abrading surface of the body. The at least one conformable polar organic-metallic coating may be in contact with the conformable metal oxide coating, i.e. the exposed surface of the metal oxide coating. The abrasive article may include an optional conformable diamond coating. The diamond coating may be in contact with the abrading surface of the body of the abrasive article. The conformable metal oxide coating may be in contact with the diamond coating, i.e. the exposed surface of the diamond coating. The at least one conformable polar organic-metallic coating may be in contact with the conformable diamond coating, i.e. the exposed surface of the diamond coating, if the conformable metal oxide coating is not present. The conformable diamond coating may include an oxidized surface containing oxygen. Combinations of the conformable polar organic-metallic coating with the conformable metal oxide coating or the conformable diamond coating may be used. Combinations of all three coatings, i.e. a conformable polar organic-metallic coating, a conformable metal oxide coating and a conformable diamond coating, may be used. For example, in one embodiment, the abrading surface of the body may first be coated with a conformable metal oxide coating, e.g. diamond like glass (DLG). The metal oxide coating is adjacent to and in contact with the plurality of inorganic abrasive particles of the abrading surface of the body. The DLG coating has an exposed first surface which may be coated with a conformable polar organic-metallic coating which includes a chemical compound having at least one metal and an organic moiety having at least one polar functional group, e.g. a conformable hydrophilic coating. The conformable polar organic-metallic coating is adjacent to and in contact with the first surface of the metal oxide coating. In some embodiments, the metal oxide coating may be a diamond coating, wherein the surface of the diamond coating has been oxidized and contains oxygen. In another embodiment, the abrading surface of the body may first be coated with a conformable, diamond coating. The diamond coating is adjacent to and in contact with the plurality of inorganic abrasive particles of the abrading surface of the body. A conformable metal oxide coating, e.g. diamond like glass (DLG), may then be coated on the exposed surface of the conformable diamond coating. The conformable metal oxide coating is adjacent to and in contact with the conformable diamond coating. An additional conformable polar organic-metallic coating (e.g. a conformable hydrophilic coating), which includes a chemical compound having at least one metal and an organic moiety having at least one polar functional group may then be coated on the exposed surface of the conformable metal oxide coating. The conformable polar organic-metallic coating is in contact with the exposed surface of the conformable metal oxide coating.

The conformable diamond coating may include at least one of a conformable nano-crystalline diamond coating, conformable micro-crystalline diamond coating, and a conformable diamond like carbon (DLC) coating. The thickness of the conformable diamond coating is not particularly limited. In some embodiments, the thickness of the diamond coating is from 0.5 microns to 30 microns, from 1 micron to 30 microns, from 5 microns to 30 microns, from 0.5 microns to 20 microns, from 1 micron to 20 microns, from 5 microns to 20 microns, from 0.5 microns to 15 microns, from 1 micron to 15 microns, or even from 5 microns to 15 microns. The conformable diamond coating may be a diamond-like carbon coating (DLC), for example. In some embodiments, the carbon atoms are present in an amount from 40 atomic percent to 95 atomic percent, from 40 atomic percent to 98 atomic from 40 atomic percent to 99 atomic percent, from 50 atomic percent to 95 atomic percent, from 50 atomic percent to 98 atomic from 50 atomic percent to 99 atomic percent, from 60 atomic percent to 95 atomic percent, from 60 atomic percent to 98 atomic, from 60 atomic percent to 99 atomic percent or even from 90-99 atomic percent, based on the total composition of the DLC. The diamond coating can be deposited on a surface, e.g. the abrading surface of the body, by conventional technology such as a plasma enhanced chemical vapor deposition (PECVD) method, a hot wire chemical vapor deposition (HWCVD) method, ion beam, laser ablation, RF plasma, ultrasound, arc discharge, cathodic arc plasma deposition, and the like, using a gas carbon source such as methane or the like or a solid carbon source such as graphite or the like, and hydrogen as needed. In some embodiments, a diamond coating with high crystallinity can be produced by HWCVD.

The conformable metal oxide coating includes at least one metal oxide, e.g. aluminum oxide, titanium oxide, chromium oxide, magnesium oxide, manganese oxide, iron oxide, cobalt oxide, nickel oxide, copper oxide, tungsten oxide, zinc oxide and silicon oxide and the like. Combinations of the metal oxides may be used, including alloys. The metal of the conformable metal oxide coating may include at least one of a transition metal and a semiconductor metal. The metal of the metal oxide may include at least one of Al, Ti, Cr, Mg, Mn, Fe, Co, Ni, Cu, W, Zn and Si. Combinations of the metals may be used. Additionally, the conformable metal oxide coating may be a diamond coating having an oxidized surface containing oxygen. The conformable metal oxide coating may include diamond like glass (DLG). The term “diamond-like glass” (DLG) refers to substantially or completely amorphous glass including carbon, silicon and oxygen, and optionally including one or more additional component selected from the group including hydrogen, nitrogen, fluorine, sulfur, titanium, and copper. Other elements may be present in certain embodiments. In some embodiments, the metal oxide coating is free of fluorine. In some embodiments, the DLG includes from 80 percent to 100 percent, from 90 percent to 100 percent, from 95 percent to 100 percent, from 98 percent to IN percent or even from 99 percent to 100 percent carbon, silicon, oxygen and hydrogen, based on a mole basis of the DLG composition. In some embodiments, the DLG includes from 80 percent to 100 percent, from 90 percent to 100 percent, from 95 percent to 100 percent, from 98 percent to 100 percent or even from 99 percent to 100 percent carbon, silicon and oxygen, based on a mole basis of the DLG composition. The amorphous diamond-like glass coatings of the present disclosure may contain clustering of atoms to give it a short-range order but are essentially void of medium and long range ordering that lead to micro or macro crystallinity which can adversely scatter radiation having wavelengths of from 180 nm to 800 nm. The term “amorphous” means a substantially randomly-ordered non-crystalline material having no x-ray diffraction peaks or modest x-ray diffraction peaks. When atomic clustering is present, it typically occurs over dimensions that are small compared to the wavelength of the actinic radiation. Useful diamond like glass coatings and methods of making thereof can be found in, for example, U.S. Pat. No. 6,696,157 (David et al.), which is incorporated by reference in its entirety herein. The metal oxide coating may be formed by conventional techniques, including, but not limited to, physical vapor deposition, chemical vapor deposition, plasma enhanced chemical vapor deposition (PECVD), reactive ion etching and atomic layer deposition. The thickness of the conformable metal oxide coating is not particularly limited. In some embodiments, the thickness of the metal oxide coating is from 0.050 micron to 0.5 micron, from 0.5 microns to 30 microns, from 1 micron to 30 microns, from 5 microns to 30 microns, from 0.5 microns to 20 microns, from 1 micron to 20 microns, from 5 microns to 20 microns, from 0.5 microns to 15 microns, from 1 micron to 15 microns or even from 5 microns to 15 microns.

The metal oxide coating may act as a “tie-layer”, improving the adhesion between the abrading surface of the body and the hydrophilic coating, i.e. the conformable polar organic-metallic coating. The metal oxide coating may also act as a “tie-layer”, improving the adhesion between the conformable diamond coating of the body and the conformable polar organic-metallic coating. The metal oxide coating may also contribute to the hydrophilic nature of the exposed surface of the coated abrasive article.

The abrasive articles of the present disclosure also include a conformable polar organic-metallic coating that includes a chemical compound having at least one metal, e.g. at least one of Si, Ti, Zr and Al, and an organic moiety having at least one polar functional group. The conformable polar organic-metallic coating may be a hydrophilic coating. The conformable polar organic-metallic coating may include a coupling agent and/or the reaction product of a coupling agent and, for example, the metal oxide surface of the metal oxide coating, i.e. the chemical compound having at least one metal and an organic moiety having at least one polar functional group may be a coupling agent and/or the reaction product of a coupling agent and, for example, the metal oxide surface of the metal oxide coating. Although not wishing to be bound by theory, a coupling agent, for example an alkoxysilane, may be hydrolyzed in the presence of moisture to form a silanol, the hydroxyl groups of the silanol may further react through a condensation mechanism with the surface of a metal oxide, which will typically have hydroxyl groups itself. The condensation reaction will result in the formation of a M-O—Si linkage and water, where M is the metal of the metal oxide surface. Coupling agents known in the art may be used, including, but not limited to, at least one of a silane coupling agent, a titanate coupling agent, a zirconate coupling agent and an aluminate coupling agent. Combination of coupling agents may be used. Mixtures may include mixtures of differing coupling agent of the same type, e.g. a mixture of two or more different silane coupling agents, or mixtures of two or more different coupling agent types, e.g. a mixture of a silane coupling agent and a titanate coupling agent. The conformable polar organic-metallic coating may include an organosilane and the conformable polar organic-metallic coating therefrom may include the reaction product of the organosilane and the metal oxide of the conformable metal oxide coating, i.e. the chemical compound having at least one metal and an organic moiety having at least one polar functional group may be an organosilane and the conformable polar organic-metallic coating therefrom may include the reaction product of the organosilane and the metal oxide of the conformable metal oxide coating. Useful organosilanes include, but are not limited to, at least one of an organochlorosilane, organosilanol and an alkoxysilane. The at least one polar functional group includes, but is not limited to, at least one of a hydroxyl, an acid (e.g. a carboxylic acid), a primary amine, a secondary amine, a tertiary amine, a methoxy, an ethoxy, a propoxy, a ketone, a cationic and an anionic functional group. In some embodiments, the organic moiety having at least one polar functional group may include at least two, at least three, at least four, at least five or even at least six polar functional groups. In some embodiments, the organic moiety having at least one polar functional group may include from one to three, from one to four, from one to six, from one to eight, from one to ten, from two to three, from two to four, from two to six, from two to eight or even from two to ten polar functional groups. If at least two polar functional groups are used, the at least two polar functional group may be the same functional groups, e.g. all hydroxyl groups, or may be combinations of different functional groups, e.g. two hydroxyl groups and a primary amine group. In some embodiments, the at least one polar functional group includes at least one of a cationic functional group and an anionic functional group. In some embodiments, the at least one polar functional group includes a cationic functional group and an anionic functional group, i.e. a zwitterion. The at least one polar functional group provides the associated conformable coating with enhanced hydrophilicity. The conformable polar organic-metallic coating, i.e. the chemical compound having at least one metal and an organic moiety having at least one polar functional group, may include at least one of a silane coupling agent, a titanate coupling agent, a zirconate coupling agent and an aluminate coupling agent; silane coupling agents, e.g. organosilanes, have particular utility.

The conformable polar organic-metallic coating which includes a chemical compound having at least one metal and an organic moiety having at least one polar functional group can be applied to a substrate (e.g. the conformable metal oxide coating), neat, but it is preferably applied from a solution thereof which includes a volatile solvent, e.g. a volatile organic solvent Such a solution may contain from 0.25 percent to about 80 percent by weight, from about 0.25 percent to about 10 percent by weight or even from 0.25 percent to 3 percent by weight of the chemical compound based on the total weight of the solution, the remainder may consist essentially of a solvent or a mixture of solvents. Examples of generally suitable solvents include, but are not limited to, water; alcohols, e.g. methanol, ethanol, and propanol; ketones, e.g. acetone and methyl ethyl ketone; hydrocarbons, e.g. hexane; cyclohexane, toluene, and the like; ethers, e.g. diethyl ether and tetrahydrofuran and mixtures thereof. Water can be present if desired, to hydrolyze a compound with one or more hydrolyzable functional groups, for example. An organic acid such as acetic acid can also be present, if desired, to stabilize a solution containing a silanol, for example. After coating, the solvent is removed from the solution, leaving a conformable polar organic-metallic coating, including a chemical compound having at least one metal and an organic moiety having at least one polar functional group on the substrate. In some embodiments, conformable polar organic-metallic may contain from 30 percent to 100 percent, from 40 to 100 percent, from 50 to 100 percent, from 60 to 100 percent; from 70 to 100 percent, from 80 to 100 percent, from 90 to 100 percent or even from 95 to 100 percent by weight of the chemical compound having at least one metal and an organic moiety having at least one polar functional group, based on the weight of the coating. The conformable polar organic-metallic coating may further include at least one of lithium silicate, sodium silicate and potassium silicate. The silicate may be present in the coating in from 1 to 70 percent, from 1 to 60 percent, from 1 to 50 percent, from 1 to 40 percent or even from 1 to 30 percent, based on the weight of the coating.

In one embodiment, the abrasive articles of the present disclosure may be fabricated as follows:

providing a body having an abrading surface and an opposed second surface, wherein the abrading surface of the body includes a plurality of inorganic abrasive particles, optionally, the inorganic abrasive particles have a Mohs hardness of at least 7.5 and/or a Vickers hardness of at least 1300 kg/mm²;

disposing a conformable metal oxide coating adjacent to and conforming to the plurality of inorganic abrasive particles, wherein the conformable metal oxide coating includes a first surface;

disposing a conformable polar organic-metallic coating in contact with the first surface of the conformable metal oxide coating, wherein the conformable polar organic-metallic coating includes a chemical compound having at least one metal (e.g. at least one of Si, Ti, Zr and Al) and an organic moiety having at least one polar functional group. In some embodiments, the conformable metal oxide coating is in contact with the abrading surface of the body.

In another embodiment, the abrasive article of the present disclosure is fabricated as follows:

providing a body having an abrading surface and an opposed second surface, wherein the abrading surface of the body includes a plurality of inorganic abrasive particles, optionally, the inorganic abrasive particles have a Mohs hardness of at least 7.5 and/or a Vickers hardness of at least 1300 kg/mm²;

disposing a conformable, diamond coating adjacent to and conforming to the plurality of inorganic abrasive particles, wherein the conformable diamond coating includes an exposed surface;

disposing a conformable metal oxide coating adjacent to and in contact with the exposed surface of the diamond coating, wherein the conformable metal oxide coating includes a first surface;

disposing a conformable polar organic-metallic coating in contact with the first surface of the conformable metal oxide coating, wherein the conformable polar organic-metallic coating includes a chemical compound having at least one metal (e.g. at least one of Si, Ti, Zr and Al) and an organic moiety having at least one polar functional group. In some embodiments, the conformable diamond coating is in contact with the abrading surface of the body.

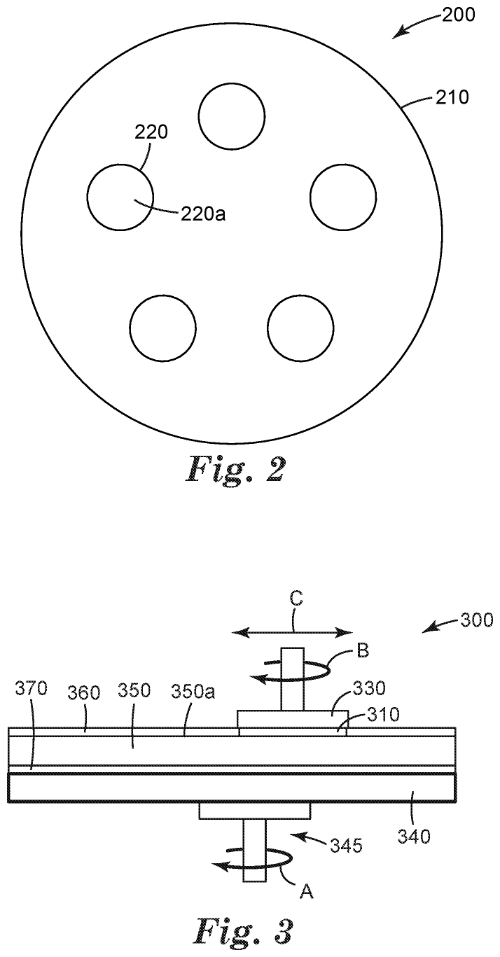

The abrasive articles of the present disclosure may find particular utility as a pad conditioner used in, for example, CMP applications. The abrasive articles may be useful for both full face pad conditioners and segmented pad conditioners. Segmented pad conditioners include at least one abrasive element attached to a second substrate, the second substrate generally having a larger projected surface area than the element. Thus, there are regions on the segmented pad conditioner surface that contain an abrading surface and regions that do not contain an abrading surface. In some embodiments, a full face pad conditioner includes an abrasive article according to any one of the present disclosure. The surface area of the full face pad conditioner may include from 50 to 100 percent, from 60 to 100 percent, from 70 to 100 percent, from 80 to 100 percent or even from 90 to 100 percent abrading surface of an abrasive article according to the present disclosure. A segmented pad conditioner includes a second substrate and at least one abrasive element; the abrasive element may be an abrasive article according to any one of the abrasive articles of the present disclosure. The second substrate may include materials as those previously described for the first substrate. FIG. 2 shows a schematic top view of a segmented pad conditioner of the present disclosure. Segmented pad conditioner 200 includes a second substrate 210 and abrasive elements 220 having abrading surface 220a. In this exemplary embodiment, segmented pad conditioner 200 includes five abrasive elements 220. Abrasive elements 220 may be any one of the abrasive articles of the present disclosure. Second substrate 210 is not particularly limited. Second substrate 210 may be a stiff material, for example, a metal. Second substrate 210 may be stainless steel, e.g. a stainless steel plate. In some embodiments, second substrate 210 has an elastic modulus of at least 1 GPa, at least 5 GPa or even at least 10 GPa. Abrasive elements 220 may be attached to substrate 210 by any means known in the art, e.g. mechanically (e.g. utilizing a screw or bolt) or an adhesive (e.g. utilizing an epoxy adhesive layer). It may be desirable to have the abrading surfaces 220a of abrasive elements 220 be substantially planar. Methods of mounting abrading elements to a substrate enabling the planar abrading surfaces of the abrading elements to be substantially planar are disclosed in U.S Pat. Publ. No. 2015/0224625 (LeHuu et al.), which is incorporate herein by reference in its entirety.

FIG. 3 schematically illustrates an example of a polishing system 300 for utilizing abrasive articles in accordance with some embodiments of the present disclosure. As shown, polishing system 300 may include a polishing pad 350, having polishing surface 350a, and a pad conditioner 310 having an abrading surface. The pad conditioner includes at least one abrasive article according to any one of the abrasive articles of the present disclosure, wherein the abrading surface of the pad conditioner includes the conformable polar organic-metallic coating of the at least one abrasive article. The system may further include one or more of the following: a working liquid 360, a platen 340 and a pad conditioner carrier assembly 330, a cleaning liquid (not shown). An adhesive layer 370 may be used to attach the polishing pad 350 to platen 340 and may be part of the polishing system. A substrate being polished (not shown) on polishing pad 350 may also be part of polishing system 300. Working liquid 360 may be a layer of solution disposed on polishing surface 350a of polishing pad 350. Polishing pad 350 may be any polishing pad known in the art. Polishing pad 350 includes a material, i.e. it is fabricated from a material. The material of the polishing pad may include a polymer, e.g. at least one of a thermoset polymer and a thermoplastic polymer. The thermoset polymer and the thermoplastic polymer may be a polyurethane, i.e. the material of the polishing pad may be a polyurethane. The working liquid is typically disposed on the surface of the polishing pad. The working liquid may also be at the interface between pad conditioner 310 and polishing pad 350. During operation of polishing system 300, a drive assembly 345 may rotate (arrow A) the platen 340 to move the polishing pad 350 to carry out a polishing operation. The polishing pad 350 and the polishing solution 360 may separately, or in combination, define a polishing environment that mechanically and/or chemically removes material from or polishes a major surface of a substrate to be polished. To abrade, i.e. condition, polishing surface 350a with pad conditioner 310, the carrier assembly 330 may urge pad conditioner 310 against polishing surface 350a of polishing pad 350 in the presence of polishing solution 360. The platen 340 (and thus the polishing pad 350) and/or the pad conditioner carrier assembly 330 then move relative to one another to translate pad conditioner 310 across polishing surface 350a of polishing pad 350. The carrier assembly 330 may rotate (arrow B) and optionally transverse laterally (arrow C). As a result, the abrading layer of pad conditioner 310 removes material from polishing surface 350a of polishing pad 350. It is to be appreciated that the polishing system 300 of FIG. 3 is only one example of a polishing system that may be employed in conjunction with the abrasive articles of the present disclosure, and that other conventional polishing systems may be employed without deviating from the scope of the present disclosure.

Select embodiments of the present disclosure include, but are not limited to, the following:

In a first embodiment, the present disclosure provides an abrasive article comprising:

a body having an abrading surface and an opposed second surface, wherein the abrading surface of the body includes a plurality of inorganic abrasive particles;

a conformable metal oxide coating adjacent to and conforming to the plurality of inorganic abrasive particles, wherein the conformable metal oxide coating includes a first surface; and

a conformable polar organic-metallic coating in contact with the first surface of the conformable metal oxide coating, wherein the conformable polar organic-metallic coating includes a chemical compound having at least one metal and an organic moiety having at least one polar functional group

In a second embodiment, the present disclosure provides an abrasive article according to the first embodiment, wherein the at least one metal of the conformable polar organic-metallic coating is at least one of Si, Ti, Zr and Al.

In a third embodiment, the present disclosure provides an abrasive article according to the first or second embodiment, wherein the at least one polar functional group includes at least one of a hydroxyl, an acid, a primary amine, a secondary amine, a tertiary amine, a methoxy, an ethoxy, a propoxy, a ketone, a cationic and an anionic functional group.

In a fourth embodiment, the present disclosure provides an abrasive article according to any one of the first through third embodiments, wherein the at least one polar functional group includes at least one of a cationic functional group and an anionic functional group.

In a fifth embodiment, the present disclosure provides an abrasive article according to any one of the first through fourth embodiments, wherein the at least one polar functional group includes at least one cationic functional group and one anionic functional group.

In a sixth embodiment, the present disclosure provides an abrasive article according to any one of the first through fifth embodiments, wherein the chemical compound is an organosilane and wherein the conformable polar organic-metallic coating includes the reaction product of the organosilane and the metal oxide of the conformable metal oxide coating.

In a seventh embodiment, the present disclosure provides an abrasive article according to the sixth embodiment, wherein the organosilane includes at least one of an organochlorosilane, organosilanol and an alkoxysilane.

In an eighth embodiment, the present disclosure provides an abrasive article according to any one of the first through seventh embodiments, wherein the organosilane includes an alkoxysilane.

In a ninth embodiment, the present disclosure provides an abrasive article according to any one of the first through seventh embodiments, wherein organosilane includes at least one of n-trimethoxysilylpropyl-n,n,n-trimethylammonium chloride, n-(trimethoxysilylpropyl)ethylenediaminetriacetate trisodium salt, carboxy ethyl silanetriol di sodium salt, 3-(trihydroxysilyl)-1-propanesulfonic acid and n-(3-triethoxysilylpropyl)gluconamide.

In a tenth embodiment, the present disclosure provides an abrasive article according to any one of the first through ninth embodiments, wherein the conformable polar organic-metallic coating further includes at least one of lithium silicate, sodium silicate and potassium silicate.

In an eleventh embodiment, the present disclosure provides an abrasive article according to any one of the first through tenth embodiments, wherein the metal of the metal oxide includes at least one of Al, Ti, Cr, Mg, Mn, Fe, Co, Ni, Cu, W, Zn, Zr, Ga and Si.

In a twelfth embodiment, the present disclosure provides an abrasive article according to the fifth embodiment, wherein the metal of the metal oxide includes Si, the organosilane includes an alkoxysilane, and the at least one polar functional group includes at least one of a cationic functional group and an anionic functional group.

In a thirteenth embodiment, the present disclosure provides an abrasive article according to any one of the first through twelfth embodiments, wherein the contact angle of water on the conformable polar organic-metallic coating is less than 30 degrees.

In a fourteenth embodiment, the present disclosure provides an abrasive article according to any one of the first through thirteenth embodiments, wherein the contact angle of water on the conformable polar organic-metallic is between from 0 degrees to 20 degrees.

In a fifteenth embodiment, the present disclosure provides an abrasive article according to any one of the first through fourteenth embodiments, further comprising a conformable, diamond coating disposed between the abrading surface of the body and the conformable metal oxide coating.

In a sixteenth embodiment, the present disclosure provides an abrasive article according to any one of the first through fifteenth embodiments, wherein the plurality of inorganic abrasive particles includes diamond abrasive particles.

In a seventeenth embodiment, the present disclosure provides an abrasive article according to the sixteenth embodiment, wherein the plurality of inorganic abrasive particles includes at least 95 percent diamond abrasive particles by weight.

In an eighteenth embodiment, the present disclosure provides an abrasive article according to any one of the first through seventeenth embodiments, wherein the inorganic abrasive particles have a Mohs hardness of at least 7.5.

In a nineteenth embodiment, the present disclosure provides an abrasive article according to any one of the first through eighteenth embodiments, wherein the inorganic abrasive particles have a Mohs hardness of at least 8.5.

In a twentieth embodiment, the present disclosure provides a polishing system comprising:

a polishing pad including a material;

a pad conditioner having an abrading surface, wherein the pad conditioner includes at least one abrasive article according to any one of the first through nineteenth embodiments, wherein the abrading surface of the pad conditioner includes the conformable polar organic-metallic coating of the at least one abrasive article.

In a twenty-first embodiment, the present disclosure provides a polishing system according to the twentieth embodiment, wherein the material of the polishing pad includes polyurethane.

In a twenty-second embodiment, the present disclosure provides a polishing system according to the twentieth or twenty-first embodiment, wherein the working liquid is an aqueous, working liquid.

In a twenty-third embodiment, the present disclosure provides a polishing system according to any one of the twentieth through twenty-second embodiments, further comprising a cleaning liquid.

In a twenty-fourth embodiment, the present disclosure provides a polishing system according to the twenty-third embodiment, wherein the cleaning liquid is an aqueous, cleaning liquid.

### EXAMPLES

MATERIALS

| Abbreviation | |
|---|---|
| or Trade Name | Description |
| Zwit silane | 3-(N,N-dimethylaminopropyl)trimethoxysilane (49.7 g, |
| | 239 mmol) was added to a screw-top jar followed by |
| | deionized (DI) water (82.2 g) and 1,4-butane sultone |
| | (32.6 g, 239 mmol). The reaction mixture was heated to |
| | 75° C. andmixed for 14 hours. |
| LSS-75 | Lithium silicate having a 22% weight solid content |
| | available as LSS-75 from Nissan Chemical Industries, |
| | Ltd., Tokyo, Japan. |
| HMDSO | Hexamethyldisiloxane, ≥98%, available as HMDSO |
| | from Sigma-Aldrich, St. Louis, MO. |
| A3799 | A diamond abrasive particle pad conditioner, available |
| | under the trade designation 3M DIAMOND PAD |
| | CONDITIONER A3799, 4.25 inch Diameter. |

### Preparatory Coating Solutions

### Preparative Solution A:

Preparative Solution A was prepared as a 5 wt. % solution of Zwit silane/LSS-75 (30/70 w/w) in deionized water.

### Testing Methods

### Conditioning Test Method:

Conditioning was conducted using a CETR-CP4 (available form Bruker Company) having a. 9 inch (23 cm) diameter platen. A 9 inch (23 cm) diameter IC1000 pad (available from Dow Chemical) was mounted on the platen and an Example pad conditioner or Comparative Example pad conditioner was mounted on the rotating spindle of the CETR-CP4. Conditioning was conducted at a platen speed of 93 rpm and a spindle speed of 87 rpm, respectively. The downforce on the conditioner was 6 lbs (27 N) and the IC1000 pad was abraded by the pad conditioner. During the conditioning, de-ionized water flows to platen at a flow rate of 50 mL/min. The conditioning time was 30 minutes.

### Post Conditioning Visual Analysis Method:

After conditioning, the surfaces of the ceramic abrading elements were examined by optical microscopy to identify pad debris accumulation and scored on a debris rating scale of 1=completely free of debris and 5=heavily soiled with debris.

### Example 1 and Comparative Example 2

### Silica-Like Deposition by Plasma:

Silica-like (conformable metal oxide coating) plasma deposition was conducted by placing a pad conditioner, A3799, in a plasma chamber. Air was evacuated from the chamber by a mechanical pump and the chamber reached a base pressure lower than 100 mTorr before igniting the plasma. Three steps were used to deposit the silica-like layer on the surface of ceramic elements of the pad conditioner. First, the sample was cleaned by using oxygen gas, 50 sccm with rf power 300 W for 1 min. Next, deposition was conducted by exposing the surface of an element to a mixture of HMDSO/O2 50 sccm/25 sccm at rf power 300 W for 1 min. Last, the surface of the silica-like layer was oxidized by using oxygen gas, 50 sccm with rf power 300 W for 30 sec.

### Coating:

Immediately after the plasma process described above, Preparative Solution A was dripped on the surface of the plasma treated A3799 pad conditioner until the surface was fully covered by the solution. The sample was heated at 80° C. until the surface was completely dry, producing Example 1.

Comparative Example 2 (CE-2) was an A3799 pad conditioner, used as received. Example 1 and CE-2 were tested using the Conditioning Test Method, described above, and then analyzed using the Post Conditioning Visual Analysis Method, described above. After conditioning, Example 1 had a debris rating of 1 and CE-2 had a debris rating of 5.

1. An abrasive article comprising:
a body having an abrading surface and an opposed second surface, wherein the abrading surface of the body includes a plurality of inorganic abrasive particles;
a conformable metal oxide coating adjacent to and conforming to the plurality of inorganic abrasive particles, wherein the conformable metal oxide coating includes a first surface; and
a conformable polar organic-metallic coating in contact with the first surface of the conformable metal oxide coating, wherein the conformable polar organic-metallic coating includes a chemical compound having at least one metal and an organic moiety having at least one polar functional group.

2. The abrasive article of claim 1, wherein the at least one metal of the conformable polar organic-metallic coating is at least one of Si, Ti, Zr and Al.

3. The abrasive article of claim 1, wherein the at least one polar functional group includes at least one of a hydroxyl, an acid, a primary amine, a secondary amine, a tertiary amine, a methoxy, an ethoxy, a propoxy, a ketone, a cationic and an anionic functional group.

4. The abrasive article of claim 1, wherein the at least one polar functional group includes at least one of a cationic functional group and an anionic functional group.

5. The abrasive article of claim 1, wherein the at least one polar functional group includes at least one cationic functional group and one anionic functional group.

6. The abrasive article of claim 1, wherein the chemical compound is an organosilane and wherein the conformable polar organic-metallic coating includes the reaction product of the organosilane and the metal oxide of the conformable metal oxide coating.

7. The abrasive article of claim 6, wherein the organosilane includes at least one of an organochlorosilane, organosilanol and an alkoxysilane.

8. The abrasive article of claim 1, wherein the organosilane includes an alkoxysilane.

9. The abrasive article of claim 1, wherein organosilane includes at least one of n-trimethoxysilylpropyl-n,n,n-trimethylammonium chloride, n-(trimethoxysilylpropyl)ethylenediaminetriacetate trisodium salt, carboxyethylsilanetriol disodium salt, 3-(trihydroxysilyl)-1-propanesulfonic acid and n-(3-triethoxysilylpropyl)gluconamide.

10. The abrasive article of claim 1, wherein the conformable polar organic-metallic coating further includes at least one of lithium silicate, sodium silicate and potassium silicate.

11. The abrasive article of claim 1, wherein the metal of the metal oxide includes at least one of Al, Ti, Cr, Mg, Mn, Fe, Co, Ni, Cu, W, Zn, Zr, Ga and Si.

12. The abrasive article of claim 5, wherein the metal of the metal oxide includes Si, the organosilane includes an alkoxysilane, and the at least one polar functional group includes at least one of a cationic functional group and an anionic functional group.

13. The abrasive article of claim 1, wherein the contact angle of water on the conformable polar organic-metallic coating is less than 30 degrees.

14. (canceled)

15. The abrasive article of claim 1, further comprising a conformable, diamond coating disposed between the abrading surface of the body and the conformable metal oxide coating.

16. The abrasive article of claim 1, wherein the plurality of inorganic abrasive particles includes diamond abrasive particles.

17. The abrasive article of claim 16, wherein the plurality of inorganic abrasive particles includes at least 95 percent diamond abrasive particles by weight.

18. (canceled)

19. The abrasive article of claim 1, wherein the inorganic abrasive particles have a Mohs hardness of at least 8.5.

20. A polishing system comprising:
a polishing pad including a material;
a pad conditioner having an abrading surface, wherein the pad conditioner includes at least one abrasive article of claim 1, wherein the abrading surface of the pad conditioner includes the conformable polar organic-metallic coating of the at least one abrasive article.

21. The polishing system of claim 20, wherein the material of the polishing pad includes polyurethane.

22. (canceled)

23. The polishing system of claim 20, further comprising a cleaning liquid.

24. (canceled)
